(19) United States
(12) Patent Application Publication
(10) Pub. No.: US 2020/0329829 A1
(43) Pub. Date: Oct. 22, 2020

(54) HAND BENDABLE METAL DISK WITH CORE AREA AND RING AREA

(71) Applicant: MCPATENT GMBH, München (DE)

(72) Inventor: Ingolf BODE, Unterschleißheim (DE)

(21) Appl. No.: 16/772,850

(22) PCT Filed: Dec. 14, 2018
(86) PCT No.: PCT/EP2018/085072

§ 371 Date: Jun. 15, 2020

(30) Foreign Application Priority Data
Dec. 14, 2017 (DE) 10 2017 011 573.7

(51) Int. Cl. A44C 3/00; A44C 21/00; F21V 7/22

(52) U.S. Cl. CPC A44C 3/002; F21V 7/22; A44C 21/00

(57) ABSTRACT

The invention relates to a metal disk (2) comprising a circular core region (4) and a circular annular region (5), wherein the core region and the annular region are integrally formed and embossed, the core region is provided in the interior of the annular region, the annular region comprises a plurality of uniform segment portions (3), the core region is delimited from the annular region on an upper side of the metal disk by means of a peripheral closed peripheral groove (7) and each segment portion in the annular region is delimited from each adjacent fan-shaped segment portion by a radial groove (8) which ends at the closed peripheral groove, the direction of each radial groove extends on a straight line from a center point (M) of the metal disk to an outer edge of the annular region of the disk, and the segment portions can be manually bent around the peripheral groove relative to the core region in one direction.

The invention relates to a metal disk with a circular core area and a circular ring area. Metal disks of this type are known, for example, as two-euro coins, the core region, which is referred to there as the pill, having a different material than the ring region. For this reason, such metal disks are called bimetal coins.

Coins from the 11th Century known as Aspron, which are Byzantine bowl coins. Such bowl-shaped coins are known until modern times. A well-known example is the bowl-shaped 1 dollar coin from 2014 “National Baseball Hall of Fame”. These coins lack sufficient stability on the underside of the bowl. In addition, the material abrasion on the underside of the coin is due to the almost punctiform support area in the center increased.

An object of the invention is to provide a metal disk which is suitable as a bowl and in which material wear is distributed more evenly.

To achieve the object, a metal disk is proposed, comprising a circular core area and a circular ring area, the core area and the ring area being formed and embossed in one piece, the core area being present in the interior of the ring area, the ring area comprising a plurality of uniform segment sections, wherein the core area is delimited from the ring area on an upper side of the metal disk by means of a circumferential, closed circumferential groove and each segment section in the ring area is delimited from each adjacent fan-shaped segment section by a radial groove which ends at the closed circumferential groove, the direction of each radial groove extends on a straight line from a center of the metal disk to an outer edge of the ring area of the disk, the segment sections being able to be bent manually in one direction relative to the core area around the circumferential groove and can be broken off from one another manually.

Due to the well-known LED technology, such metal disks can be used well as reflector screens and therefore as part of a small light emitter. Furthermore, such coins can be stored as usual and shaped into bowls if necessary. In this case, the walls of the

The aforementioned plurality of segment sections is 2 to 12.

sides of each radial groove necessarily collide at the outer edge of the ring area and thus form a stop and thus a bowl inclination defined by the formation of the groove.

In a further development of the invention, it is proposed to continue to use the metal disk as a light source and to design a coin as a reflector, which can be used to focus the light of a light-emitting diode more closely by manual adjustment.

In particular, a coin blank is proposed, comprising segments which can be manually broken off from one another by grooves, an inner segment being surrounded by a plurality of uniform outer segments and the outer segments being able to be bent by hand in such a way that they form a screen around the outer segment.

In addition to a strictly mathematically defined circle, every regular N-sided polygon, where N is a natural number, with N>4, is considered circular. In particular, a regular 5-sided polygon (pentagon) is considered circular in the sense of the invention.

Uniform within the meaning of the invention are, in particular, elements which have an identical shape and an identical size.

The metal disk can be further developed in that all elements of the metal disk can be broken off from one another manually along their grooves.

The metal disk can be further developed in that the metal disk has a circumferential groove and radial grooves on the underside, which correspond to the circumferential groove and the radial grooves on the top.

The metal disk can further be developed in that the metal disk is made of a noble metal alloy.

The metal disk can also be further developed in that the metal disk is a coin or a medal.

The metal disk can also be further developed in that each element of the metal disk has an indication of the noble metal, the fine weight and the fineness.

The metal disk can also be further developed in that a relief results in a defined volume for each element defined laterally by grooves from its neighbors, in that predetermined relief projections are compensated for by relief depressions and vice versa, in order not fall below or exceed a predetermined fine weight within the constraints of a predetermined tolerance.

Furthermore, an embossing stamp for producing a metal disk according to one of the aforementioned aspects is proposed.

The invention will be explained in more detail using the example of figures. It shows

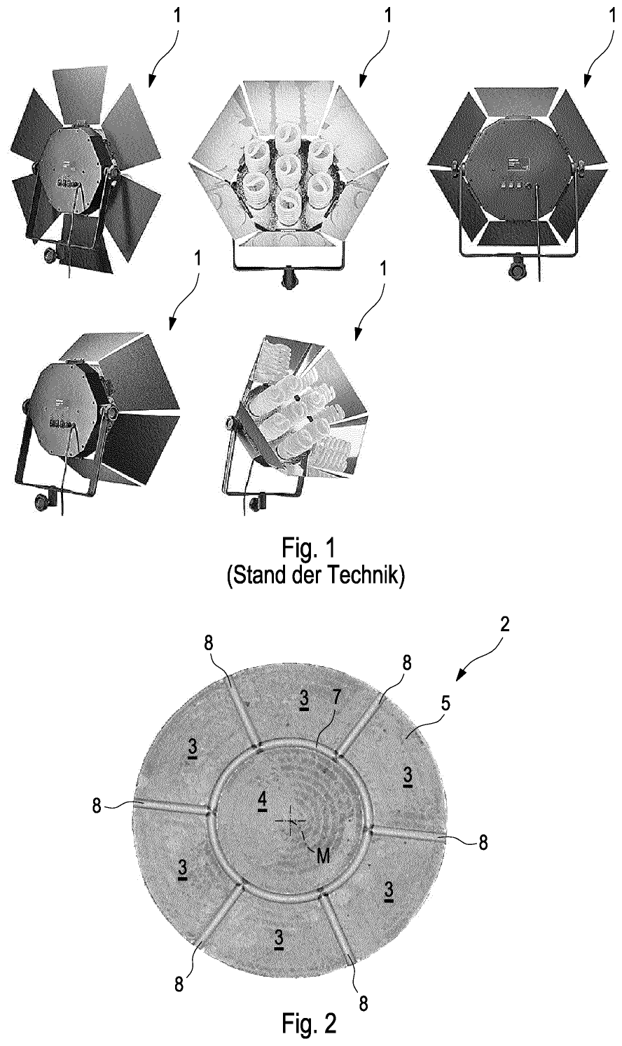

FIG. 1 State of the art in the form of a daylight lamp with reflective shielding flaps in five perspective views;

FIG. 2 is a photograph of a metal disk according to the invention with grooves embossed on both sides

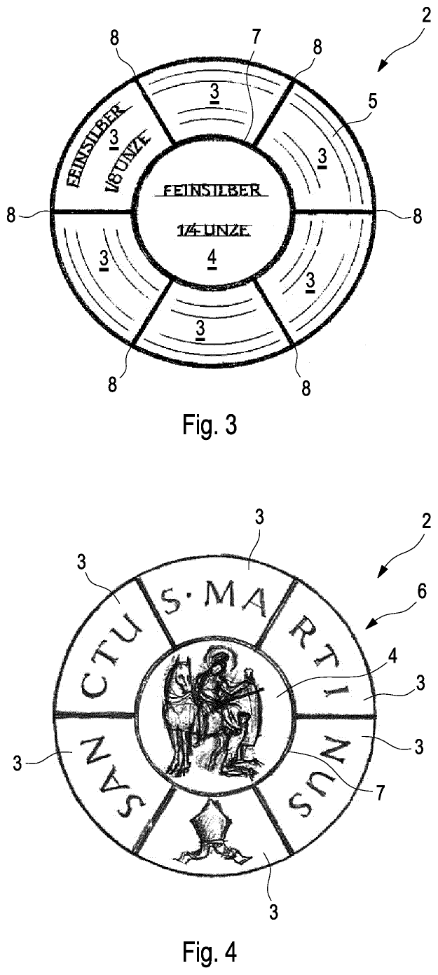

FIG. 3 is a drawing for a stamp template

FIG. 4 is a drawing for the top for a stamp template

The daylight lamp 1 shown in FIG. 1 in several perspectives is only used for illustration of the principle of bundled light reflection achievable with the metal disk according to the invention.

Bundling takes place in the case of the metal disk 2 (FIG. 2) by bending the six segment sections 3 in the direction of the viewer. It goes without saying that the groove flanks on the outer edge of the metal disk 2 abut one another from a certain bending angle and thus prevent further bending in this direction. Incidentally, the thickness of the metal disk shown is approximately 2.2 mm, so that the segment sections 3 and the core area 4 cannot be bent manually. The metal disk has a diameter of approximately 40 mm and weighs approximately 31 g (one ounce). The metal disk is made of fine silver.

The metal disk 2 shown in FIG. 1 in the form of a coin blank has a circular core area 4 with a quarter ounce fine weight. A circular ring area 5 of three-quarters of an ounce is formed around the core area 4, the core area 4 and the ring area 5 being embossed in one piece, that is to say from a piece of silver. The ring area 5 has six fan-shaped segment sections 3 of one-eighth ounce each (FIG. 4). The core area 4 is delimited from the ring area S on an upper side 6 of the metal disk 2 by means of a circumferential, closed circular circumferential groove 7. Each of the six segment sections 3 in the ring area 5 is further delimited from each adjacent segment section by a radial groove 8. Each radial groove 8 ends at the closed circumferential groove 7, the direction of each radial groove running on a straight line from a center point M of the metal disk to an outer edge of the ring region 5 of the metal disk, the segment sections 3 being manually bendable relative to the core region 4 around the circumferential groove 7 in one direction. In the case of repeated bending back and forth, breaking can be achieved and the metal disk 2 can be broken down into seven individual parts.

FIG. 3 shows an underside of a metal disk with exemplary information on the fine weight, the fineness and the material of the metal disk in the form of a medal. FIG. 4 shows the top of this medal. Both sides are created by the medalist Erich Ott.

1. Metal disk having a circular core region and a circular ring region, the core region and the ring region being formed and embossed in one piece, the core region being present inside the ring region, the ring region comprising a plurality of uniform segment sections, the core region of the ring region being on one top of the metal disk by means of a circumferential, closed circumferential groove and each segment section in the ring area is delimited from each adjacent fan-shaped segment section by a radial groove which ends at the closed circumferential groove, the direction of each radial groove on a straight line from a center point of the metal disk to an outer edge of the ring area of the disk runs, the segment sections being able to be bent manually in one direction relative to the core area around the circumferential groove.

2. Metal disk according to claim 1, wherein all elements of the metal disk can be broken off from one another manually along their grooves.

3. Metal disk according to claim 1 or 2, wherein the metal disk on the underside has a circumferential groove and radial grooves which correspond to the circumferential groove and the radial grooves of the top.

4. Metal disk according to one of the preceding claims, wherein the metal disk is made of a noble metal alloy.

5. Metal disk according to one of the preceding claims, wherein the metal disk is a coin or a medal.

6. Metal disk according to one of the preceding claims, wherein each element of the metal disk has an indication of the noble metal, the fine weight and the fineness.

7. Metal disk according to one of the preceding claims, wherein the relief results in a defined volume for each element defined laterally by grooves from its neighbors, in that predetermined relief projections are compensated for by relief depressions and vice versa.

8. Embossing stamp for producing a metal disk according to one of the preceding claims.
